(19) United States
(12) Patent Application Publication
(10) Pub. No.: US 2007/0167860 A1
(43) Pub. Date: Jul. 19, 2007

(54) Expert system for acupuncture and moxibustion

(76) Inventor: Tung-Wei Pan, Banqiao City (TW)

Correspondence Address: TROXELL LAW OFFICE PLLC, SUITE 1404, 5205 LEESBURG PIKE, FALLS CHURCH, VA, 22041, US

(21) Appl. No.: 11/293,203

(22) Filed: Dec. 5, 2005

(51) Int. Cl. A61H 39/02

(52) U.S. Cl. 600/548

(57) ABSTRACT

The present invention provides an expert system which exactly examines abnormal meridians and, through a kind of filtering and comparing, obtains adaptive acupoints for a patient as a reference for a medical treatment personnel.

### FIELD OF THE INVENTION

The present invention relates to an expert system; more particularly, relates to, through a filtering and comparing, exactly examining abnormal meridians for obtaining adaptive acupoints for a patient as a reference for a medical treatment personnel.

### DESCRIPTION OF THE RELATED ARTS

A traditional acu-mox therapy can do a treatment by a specific acupoint through a Ryodoraku therapy. Yet, some defects exit:

A) Regarding a general acu-mox therapy:

1) A general acu-mox system is based on 12 meridians. Yet, until now, a scientific method for a diagnosis and comparison is in lack. Hence, Ah-Shi-point therapy (by acupuncturing a tender point) is almost always taken, where its effect does not last long.
2) Traditional acu-mox documents show that one acupuncture point may obtain different therapy effects when applying to different illnesses. Different patients of the same illness might be applied with therapies on different acupoints to obtain good effects. Yet, clinical difficulties occur because most therapists are not able to select adaptive acupoints in a short time.
3) A traditional acu-mox therapy requires complex information.

Except 360 international certified acupoints, some more than 1000 acupoints are still left un-integrated and so perplex many acu-mox learners.

B) In another hand, regarding Ryodoraku therapy:

1) There are some disadvantages on Ryodoraku examination, such as no coffee is allowed to the examinee, no examination after sports, etc.

Sometimes, adaptive acu points for a therapy are not figured out at a real time.
2) Only 24 therapy points are defined in Ryodoraku therapy, which is too simple and hard to generally obtain expected effect.
3) Ryodoraku therapy can only annotate autonomic nerves, lack of a combination of (TCM)traditional Chinese Medicine theories.

Hence, the prior arts do not fulfill users' requests on actual use.

### SUMMARY OF THE INVENTION

The main purpose of the present invention is to, through a filtering and comparing, exactly examine abnormal meridians for obtaining adaptive acupoints for a patient as a reference for a medical treatment personnel.

To achieve the above purpose, the present invention is an expert system for acupuncture and moxibustion, comprising an acu-mox unit having a plurality of contact parts to contact with acupoints of a body; a data-processing unit electronically connecting to the acu-mox unit to receive meridian messages from the acu-mox unit; an expert device connecting to the data-processing unit to receive data from the data-processing unit for obtaining a symptom through a filtering and comparing; and a diagnosis device connecting to the expert device for obtaining suggested acu points through a filtering and comparing for treating the symptom. Accordingly, a novel expert system for acupuncture and moxibustion is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a block view of a preferred embodiment according to the present invention; and

FIG.2 is a block view showing a state of use of the preferred embodiment according to the present invention.

### DESCRIPTION OF THE PREFERRED EMBODIMENTS

The following description of the preferred embodiment is provided to understand the features and the structures of the present invention.

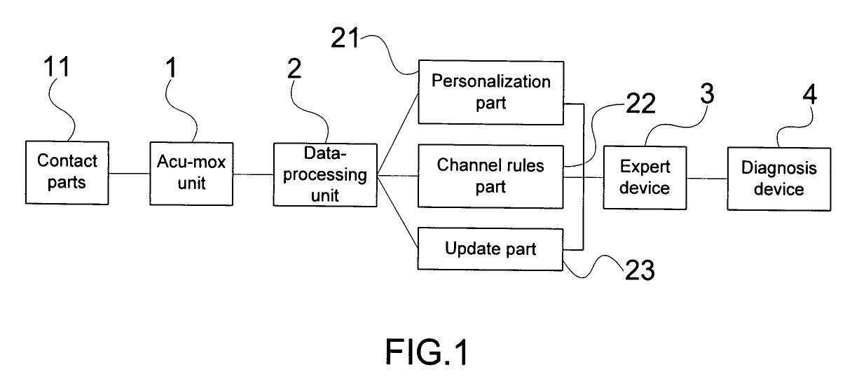

Please refer to FIG. 1, which is a block view of a preferred embodiment according to the present invention. As shown in the figure, the present invention is an expert system for acupuncture and moxibustion, comprising an acu-mox unit 1, a data-processing unit 2, an expert device 3 and a diagnosis device 4, where abnormal meridians are examined and adaptive acu points for a patient are filtered out as a reference for a therapy by a medical treatment personnel.

The acu-mox unit 1 comprises a plurality of contact parts 11 to contact with acupoints on a human body.

The data-processing unit 2 is electronically connected with the acu-mox unit 1 to receive meridian messages of the acupoints for obtaining a detected symptom and a first set of acupoints through a filtering of the meridian messages. The data-processing unit 2 is operated with a computer software; and comprises a personalization part 21, a channel rules part 22 and an update part 23.

The expert device 3 is connected with the data-processing unit 2 to receive the detected symptom and the first set of acupoints for obtaining an estimated symptom and a second set of acupoints.

The diagnosis device 4 is connected with the expert device 3 to obtain a third set of acupoints for dealing with the estimated symptom, where the third set of acupoints is obtained through a filtering and comparing of the estimated symptom and the second set of acupoints.

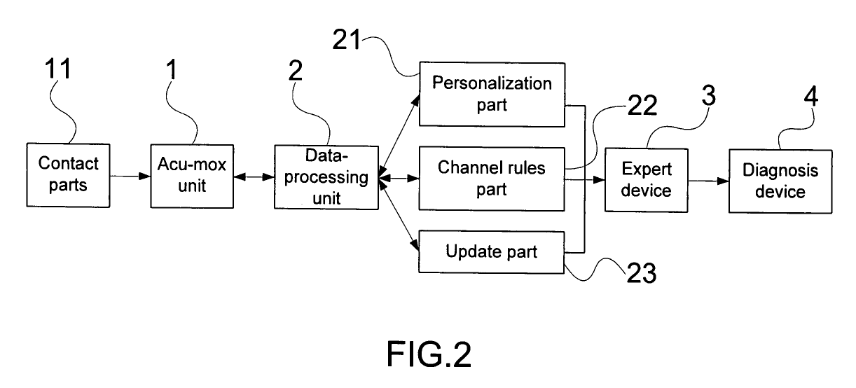

Please refer to FIG. 2, which is a block view showing a state of use of the preferred embodiment according to the present invention. As shown in the figure, when using the present invention, a plurality of contact parts 11 of an acu-mox unit 1 is contacted with acupoints on a human body. An illness name and a symptom for a patient are inputted by a personalization part 21 of a data-processing unit 2 before processing an examination. At the same time, a preferred acu-mox therapy (in a database), including acupuncture positions and acupuncture techniques, are selected in a channel rules part 22 to automatically output a suggestion of a first set of acu points by the data-processing unit 2, where the acu-mox therapy selected from an international-certified-point acu-mox therapy (having 360 acupoints), an extra-point acu-mox therapy (having 750 acupoints), a Tung's acupuncture therapy (having 650 acupoints), an Ear acupuncture therapy (having 260 acupoints), a hand acupuncture therapy (having 250 acupoints), a foot acupuncture therapy (having 80 acupoints), a head acupuncture t therapy (having 20 acupoints), a midnight-noon-ebb-flow acu-mox therapy (having 66 acupoints), a wrist-and-ankle-point acu-mox therapy (having 12 acupoints), a belly-point acu-mox therapy, (having 60 acupoints),a face acupuncture therapy (having 60 acupoints) and an eye acupuncture therapy (having 13 acupoint). When processing the examination, the data-processing unit 2 receives meridian messages outputted from the acu-mox unit, and a filtering and comparing of meridian messages is processed with the selected acu-mox therapy to obtain a detected symptom. The expert device 3 then obtains an estimated symptom and a suggestion of a second set of acupoints according to the first set of acupoints together with an input of a therapy period of time and “Excess and Deficient Symptoms” of meridians. In the end, a diagnosis device 4 exactly examines the abnormal meridians in the body, and processes a filtering and comparing of the estimated symptom and the second set of acupoints to obtain a third set of acupoints which is adaptive to the patient as a reference for a medical treatment personnel.

The present invention is an advanced meridian acu-mox therapy with non-invasion, where all known channels in human's body are integrated to build an advanced database so that an acu-mox-therapy learner may obtain suggestions of acupoints for an illness or a symptom in a very short time. And, through a further filtering and comparing by using a Ryodoraku examination method, a few adaptive acupoints for therapy are suggested, which saves 90% of time than before.

To sum up, the present invention is an expert system for acupuncture and moxibustion, where, by a data-processing unit and an expert device, abnormal meridians in body are exactly examined and, through a filtering and comparing, adaptive acupoints for a patient are obtained as a reference for a medical treatment personnel.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. An expert system for acupuncture and moxibustion, comprising:
(a) an acu-mox unit comprising a plurality of contact parts to contact with a plurality of acupoints on a human body;
b) a data-processing unit connecting electronically to said acu-mox unit to receive meridian messages of said acupoints, said data-processing unit obtaining a detected symptom and a first set of acupoints;
(c) an expert device connecting to said data-processing unit to receive said detected symptom and said first set of acupoints, said expert device obtaining an estimated symptom and a second set of acupoints; and
(d) a diagnosis device connecting to said expert device to obtain a third set of acupoints for said estimated symptom, said third set of acupoints obtained through a filtering and comparing of said estimated symptom and said second set of acupoints.

2. The expert system according to claim 1, wherein said data-processing unit is operated through computer software.

3. The expert system according to claim 1, wherein said data-processing unit comprises a personalization part, a channel rules part and an update part.

4. The expert system according to claim 1,
wherein said channel rules part comprises a database of a plurality of acu-mox therapies; and
wherein said acu-mox therapies comprises an international-certified-point acu-mox therapy, an extra-point acu-mox therapy, a Tung's acupuncuture therapy, a ear acupuncuture therapy, a hand acupuncuture therapy, a foot acupuncuture therapy, a head acupuncuture therapy, a midnight-noon-ebb-flow acu-mox therapy, a wrist-and-ankle-point acu-mox therapy, a belly-point acu-mox therapy, a face acupuncture therapy and an eye acupuncture therapy.
